(19) United States
(12) Patent Application Publication
(10) Pub. No.: US 2013/0227180 A1
(43) Pub. Date: Aug. 29, 2013

(54) METHOD FOR INPUT/OUTPUT LOAD BALANCING USING VARIED PERFORMING STORAGE DEVICES

(71) Applicants: Pradeep Bisht, Mountain View, CA (US); Jiurong Cheng, Milpitas, CA (US)

(72) Inventors: Pradeep Bisht, Mountain View, CA (US); Jiurong Cheng, Milpitas, CA (US)

(21) Appl. No.: 13/405,216

(22) Filed: Feb. 24, 2012

(51) Int. Cl. G06F 3/00

(52) U.S. Cl. 710/39

(57) ABSTRACT

An invention is provided for distributing storage I/O loads across multiple storage devices with different performance characteristics. The method includes examining a current I/O request to determine characteristics of the current I/O request. The characteristics of the current I/O request are then compared to characteristics of other pending I/O request. Then, a storage device is selected from a plurality of storage devices based on the characteristics of the current I/O request and the characteristics of other pending I/O request. Here, the plurality of storage devices includes at least one storage device having higher performance characteristics than another storage device of the plurality of storage devices. Once selected, the selected storage device is utilized with the current I/O request.

### BACKGROUND OF THE INVENTION

1. Field of the Invention

This invention relates generally to I/O for storage devices, and more particularly to I/O load balancing when utilizing multiple storage devices having varied performance characteristics.

2. Description of the Related Art

Traditionally, load balancing was an activity performed by systems utilizing multiple storage mediums having the same performance characteristics, such as a redundant array of independent disks (RAID). A RAID is an organization of multiple storage disks that performs as a single logical disk. By placing the data on multiple storage devices, input/output (I/O) operations can be performed in a balanced way, improving overall performance and fault tolerance.

There are various RAID configurations that are used to improve either disk performance or reliability. For example, RAID 0 is a RAID technology that distributes data across multiple disks to improve overall storage performance of the system. In this methodology, write requests are managed such that the data for a given request is divided equally between all the actual storage disks of the RAID 0 array and dispatched in parallel, thus improving speed and allowing more data to be piped to storage. However, since the data is distributed across multiple disks, any drive failure destroys the entire RAID array. Hence, if increased reliability is desired RAID 1 mirroring can be used.

In a RAID 1 array, data is mirrored among the various drives of the array. That is, the same data is dispatched to each drive of a RAID 1 array whenever data is written to storage. As a result, the failure of any one drive in the array does not destroy the entire array. Hence, a RAID 1 array enhances reliability of a systems storage capability. This addition reliability, however, results in slower overall performance of the RAID 1 array. Thus, the particular RAID configuration used for any particular system depends on the needs of the system, either increased performance or increased reliability.

However, the limiting assumption in all RAID configurations is that all the disk components of the RAID array are of the same type and same size. Because all the disk components are the same size with the same performance in terms of bandwidth and latency, the overall performance of the RAID array is predictable. That is, since all the disks have the same performance characteristics, same capacity, etc., a user is guaranteed that all parallel requests sent to the disks will finish at about the same time. However, when the storage devices are not the same and do not have the same characteristics this assumption does not hold. In fact, there can be situations in which the same performance of the storage devices is not desirable. In these cases a new performance paradigm is needed.

In view of the foregoing, there is a need for systems and methods for load balancing using varied performing storage devices. The systems and methods should allow the use of different storage devices in a manner that improves performance by utilizing the strengths of each particular type of storage device in the system.

### SUMMARY OF THE INVENTION

Broadly speaking, embodiments of the present invention address these needs by providing a method for distributing storage I/O loads across multiple storage devices with different performance characteristics in order to improve system I/O throughput. Embodiments of the present invention evaluate the performance of the various storage devices to determine how to balance the load of I/O requests. Then, based on the characteristics of the particular request, the characteristics of the other pending requests, and the characteristics of other recently completed I/O requests, embodiments of the present invention determine which storage device of the system to utilize for the request.

In one embodiment, a method for distributing storage I/O loads across multiple storage devices with different performance characteristics is disclosed. The method includes examining a current I/O request to determine characteristics of the current I/O request. The characteristics of the current I/O request are then compared to characteristics of other pending I/O requests. Then, a storage device is selected from a plurality of storage devices based on the characteristics of the current I/O request and the characteristics of other pending I/O requests. Here, the plurality of storage devices includes at least one storage device having higher performance characteristics than another storage device of the plurality of storage devices. Once selected, the selected storage device is utilized with the current I/O request. One characteristic of the current I/O request can be the size of the current I/O request. Another characteristic of both the pending requests and the current I/O request utilized by embodiments of the present invention can be the locality of the current I/O request. For example, the higher performance storage device can be selected when the locality of the pending requests and the locality of current I/O request target non-sequential locations. Similarly, a lower performance storage device can be selected when the locality of the pending requests and the locality of current I/O request target sequential locations.

In a further embodiment, a system is disclosed for distributing storage I/O loads across multiple storage devices with different performance characteristics. The system includes an I/O request queue queuing a plurality of pending requests. The system also includes a plurality of storage devices in communication with the I/O request queue. Similar to above, the plurality of storage devices includes a low performance storage device and a higher performance storage device. For example, the higher performance storage device can be a solid state drive, and a lower performance storage device can be a hard disk drive. Further included is a processor executing program instructions that examine a current I/O request to determine characteristics of the current I/O request, and compare the characteristics of the current I/O request to characteristics of other pending I/O request. In operation, the processor selects a storage device from a plurality of storage devices based on the characteristics of the current I/O request and the characteristics of other pending I/O requests. The selected storage device then is utilized with the current I/O request. As above, characteristics can be the size and locality of the current I/O request and the locality of the pending I/O requests.

A computer program embodied on a computer readable medium for distributing storage I/O loads across multiple storage devices with different performance characteristics is disclosed in a further embodiment of the present invention. The computer program includes computer code for examining a current I/O request to determine characteristics of the current I/O request, and computer code for comparing the characteristics of the current I/O request to characteristics of other pending I/O requests. In addition, computer code is included for selecting a storage device from a plurality of storage devices based on the characteristics of the current I/O request and the characteristics of other pending I/O requests, wherein the plurality of storage devices includes at least one storage device having higher performance characteristics than another storage device of the plurality of storage devices. Computer code is further included for utilizing the selected storage device with the current I/O request.

In this manner, embodiments of the present invention allow system throughput to be improved through the use of proper load balancing between the varied performance drives of the computer system. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing an exemplary computer system, in accordance with an embodiment of the present invention;

FIG. 2 is a flowchart showing a method for system setup of an asymmetric I/O load balancing system, in accordance with an embodiment of the present invention;

FIG. 3 is a flowchart showing a method for distributing storage I/O loads across multiple storage devices with different performance characteristics in order to improve system I/O throughput, in accordance with an embodiment of the present invention;

FIG. 4A illustrates one manner in which write requests are handled utilizing the methods of the embodiments of the present invention;

FIG. 4B illustrates pools of devices are utilized for handling write requests utilizing the methods of the embodiments of the present invention;

FIG. 5 is a flowchart showing a method for populating cache when using multiple storage devices with different performance characteristics in order to improve system I/O throughput, in accordance with an embodiment of the present invention; and

FIG. 6 illustrates one manner in which read requests are handled utilizing the methods of the embodiments of the present invention.

### DETAILED DESCRIPTION OF THE PREFERRED EMBODIMENTS

An invention is disclosed for input/output (I/O) load balancing using varied performing storage devices. In general, embodiments of the present invention evaluate the performance of the various storage devices to determine how to balance requests I/O requests. Then, based on the characteristics of the particular request and the characteristics of the other pending requests, embodiments of the present invention determine which storage device of the system to utilize for the request. It should be noted that, in general, the varied storage devices appear as one logical drive to a user. Thus, the embodiments of the present invention improve system performance in a manner that is essentially transparent to the end user.

It should be noted that the components of the present invention may be arranged and designed in a wide variety of different configurations in addition to the described embodiments. Thus, the following more detailed description of the embodiment of the present invention, as shown in the drawings, is not intended to limit the scope of the invention, as claimed, but is merely representative of selected presently preferred embodiments of the invention.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

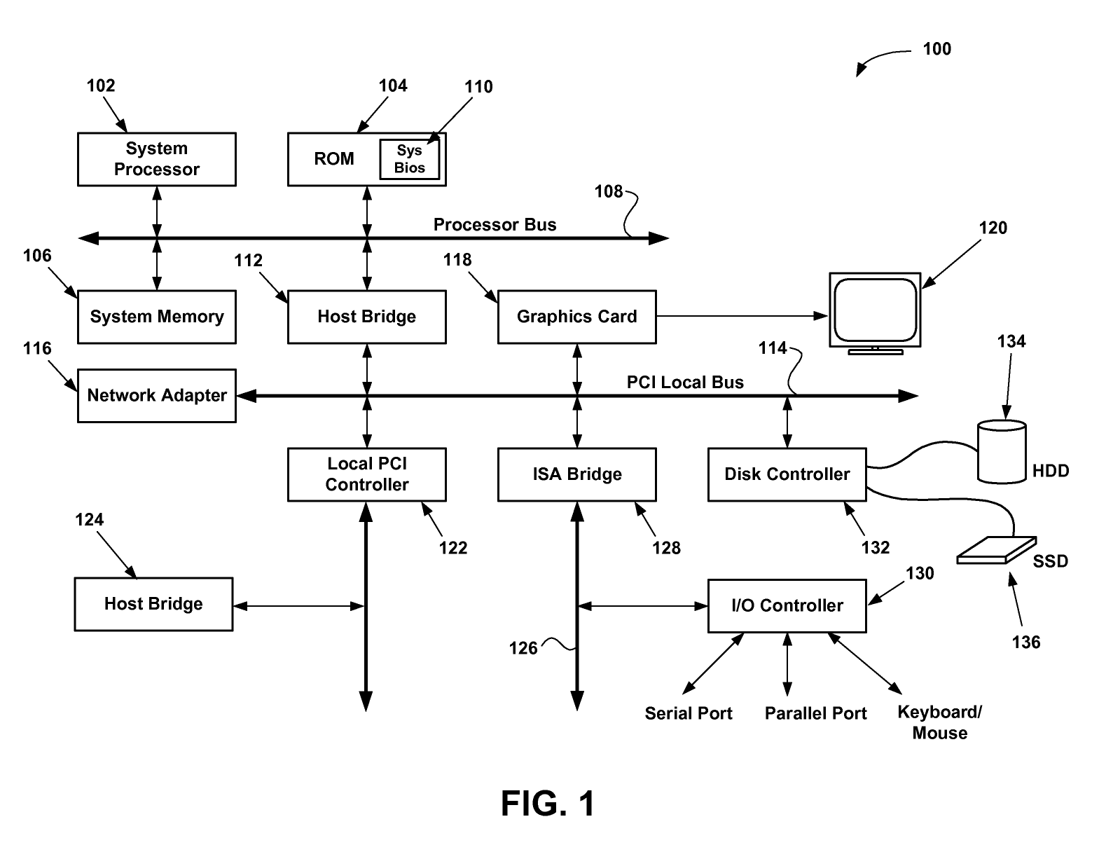

FIG. 1 is a block diagram showing an exemplary computer system 100, in accordance with an embodiment of the present invention. The exemplary computer system 100 includes a system processor 102 coupled to a read-only memory (ROM) 104 and system memory 106 via a processor bus 108. The system processor 102 executes a system BIOS 110 stored within the ROM 104 at power-on and thereafter processes data under the control of an operating system and application software stored in system memory 106. As illustrated in FIG. 1, the system processor 102 can be coupled via the processor bus 108 and host bridge 112 to a peripheral component interconnect (PCI) local bus 114.

The PCI local bus 114 supports the attachment of a number of devices, including adapters and bridges. Among these devices is a network adapter 116, which interfaces the computer system 100 to a local area network (LAN), and graphics adapter 118, which interfaces the computer system 100 to a monitor 120. Communication on the PCI local bus 114 is governed by a local PCI controller 122, which can be coupled to additional buses and devices via a second host bridge 124.

The computer system 100 further includes an industry standard architecture (ISA) bus 126 via an ISA bridge 128. Coupled to the ISA bus 128 is an I/O controller 130, which controls communication between the computer system 100 and attached peripheral devices such as a keyboard and mouse. In addition, the I/O controller 130 supports external communication by the computer system 100 via serial and parallel ports. A disk controller card 132 is in communication with various storage devices, such as a hard disk drive (HDD) 134 and a solid state drive (SSD) 136.

As mentioned above, embodiments of the present invention provide I/O load balancing for the varied performing storage devices 134 and 136. In general, embodiments of the present invention evaluate the performance of the storage devices 134 and 136 to determine how to balance requests I/O requests between them. Then, based on the characteristics of the particular request and the characteristics of the other pending requests, embodiments of the present invention determine which storage devices 134 or 136 of the computer system 100 to utilize for the request.

In this manner, embodiments of the present invention can take advantage of mixing newer types of storage technologies, such as NAND flash based SSDs or phase change memory (PCM), with HDDs to create a new performance paradigm. Although SSDs and HDDs will be used to illustrate the I/O load balancing paradigm of the embodiments of the present invention, it should be noted that the varied storage devices can be of any type. For example, a high performance SSD can be mixed with a lower performance SSD instead of an HDD.

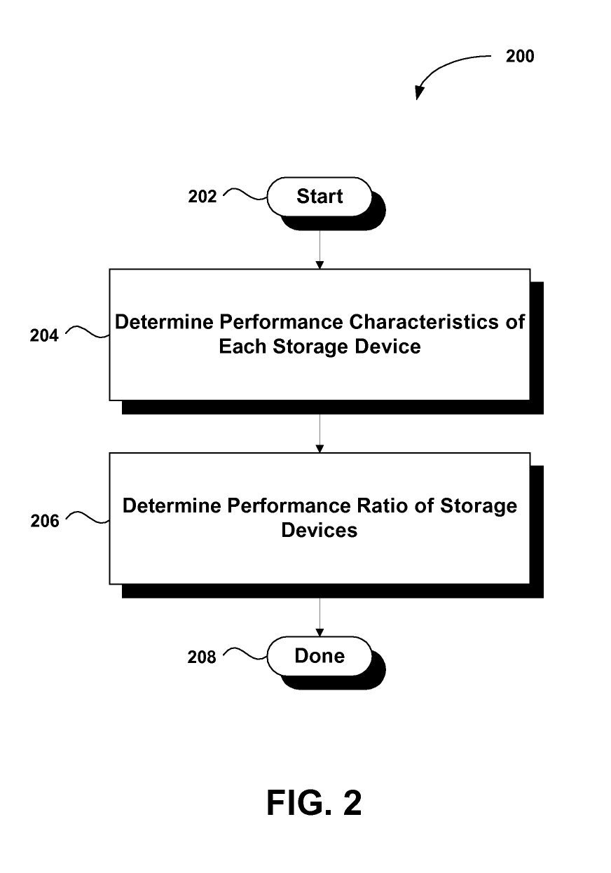

In one embodiment, during system design, the performance characteristics of the storage devices are determined to evaluate a performance ratio. FIG. 2 is a flowchart showing a method 200 for system setup of an asymmetric I/O load balancing system, in accordance with an embodiment of the present invention. In an initial operation 202, preprocess operations are performed. Preprocess operations can include, for example, determining the mix of drives to include in the computer system to facilitate I/O, and other preprocess operations that will be apparent to those skilled in the art with the hindsight provided after a careful reading of the present disclosure.

In operation 204, the performance characteristics of each storage device included in the computer system is determined. As mentioned above, one embodiment of the present invention combines SSDs with HDDs in order to improve system I/O throughput. Because of its rotational mechanical nature, HDDs have relatively poor I/O performance, especially for I/O read latency. SSDs on the other hand, provide superior bandwidth and latency compared to HDDs. This is especially true for random read or write access (in the range of 20-50 times higher bandwidth). For sequential access, SSD bandwidth generally is approximately 2-3 times higher than HDDs. However, SSDs have an endurance issue. That is, the memory cells of SSDs have a tendency to wear out over time with constant use.

Next, in operation 206, a performance ratio of the storage devices is determined. In the prior art, when I/O requests were received, they would be distributed evenly among the devices in a RAID array. In contrast, embodiments of the present invention distribute requests asymmetrically across the storage devices of the system based on the characteristics of the drives, the characteristics of the particular request, and the characteristics of the other pending requests. Thus, in operation 206, a performance ratio of SSD performance verses HDD performance is determined. The determined performance ratio is then used during system operation to assist in request distribution across the varied storage devices in the system.

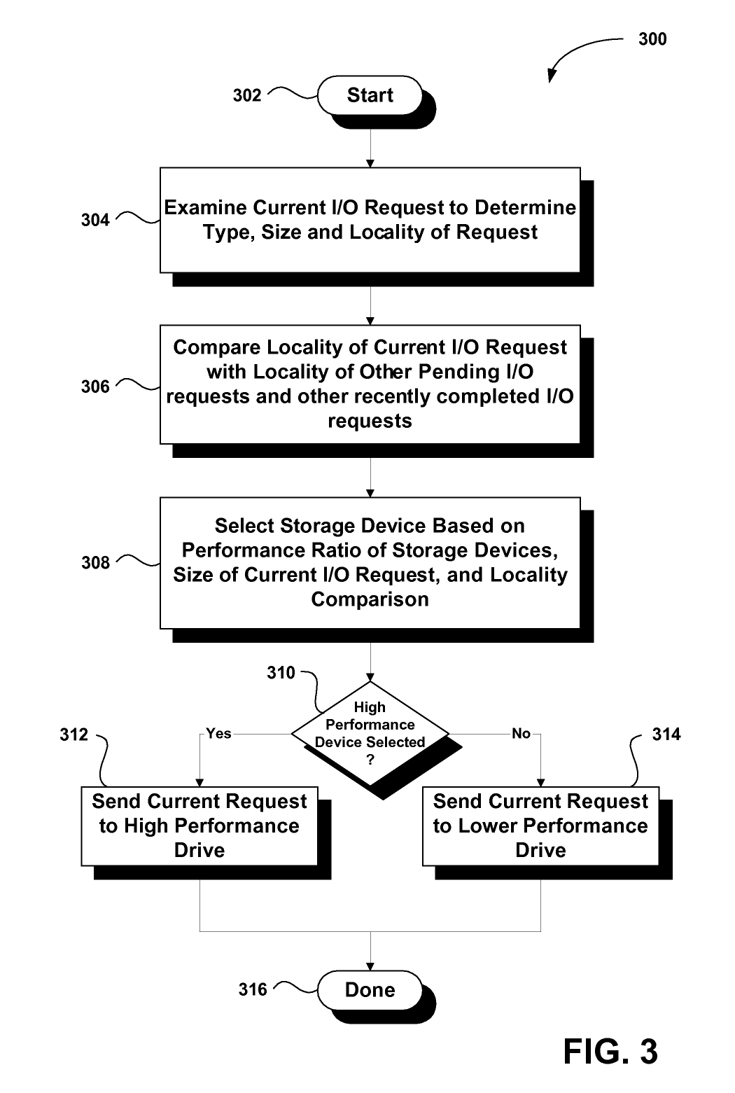

Post process operations are then performed in operation 208. Post process operations can include, for example, storage of the performance ratio, receiving new I/O write requests, and other post process operations that will be apparent to those skilled in the art with the hindsight afforded by a careful reading of the present disclosure. Once the performance ratio is determined, the ratio generally does not need to be reset or otherwise changed unless there are changes to the system. Hence, once the performance ratio is determined, the system is ready to begin distributing received requests among the storage devices of the system, as described next with reference to FIG. 3.

FIG. 3 is a flowchart showing a method 300 for distributing storage I/O loads across multiple storage devices with different performance characteristics in order to improve system I/O throughput, in accordance with an embodiment of the present invention. In an initial operation 302, preprocess operations are performed. Preprocess operations can include, for example, determining a performance ratio for the drives of the computer system, installing an Option-ROM BIOS to facilitate I/O, receiving a request, and other preprocess operations that will be apparent to those skilled in the art with the hindsight provided after a careful reading of the present disclosure.

In operation 304, the current request is examined to determine the type, size, and locality of the request. As mentioned previously, embodiments of the present invention perform load balancing based in part on the type, size, and locality of the received request.

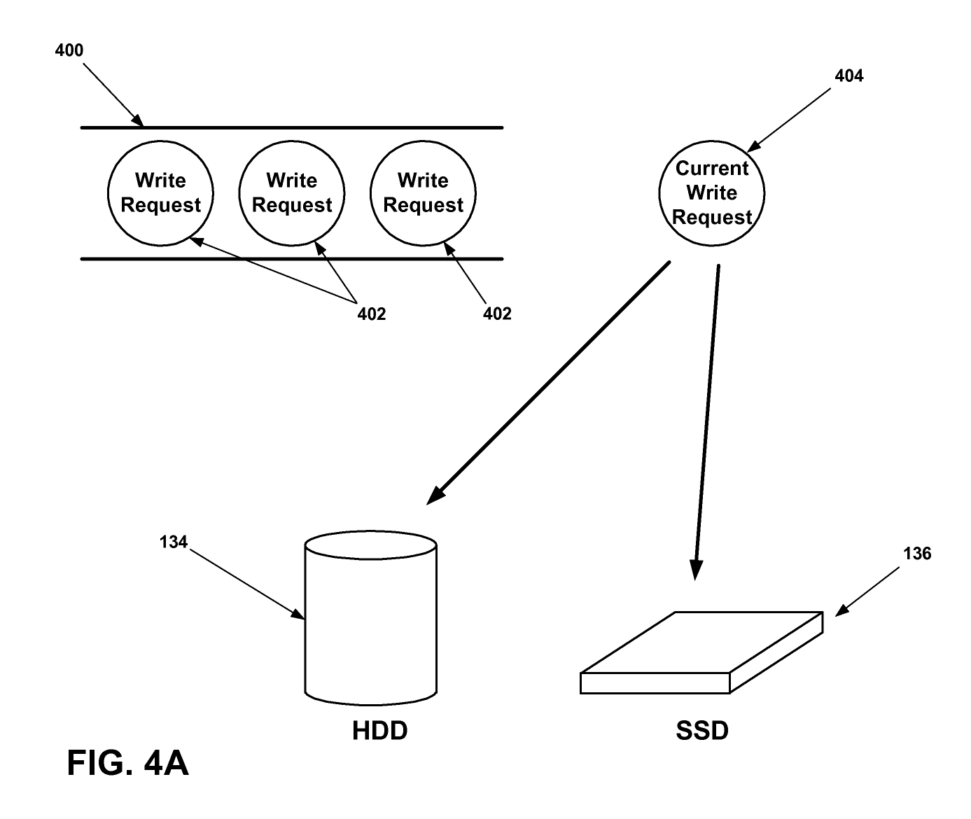

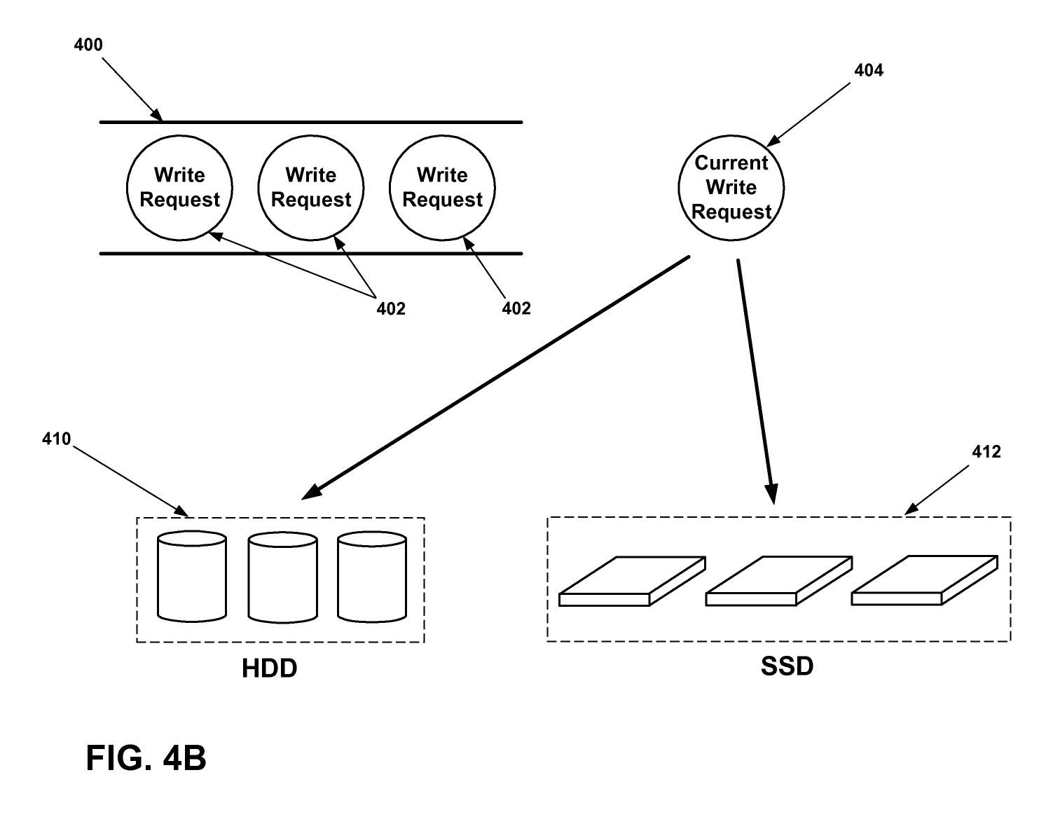

FIG. 4A illustrates one manner in which write requests are handled utilizing the methods of the embodiments of the present invention. FIG. 4A shows an I/O request queue 400 having a plurality of pending I/O requests 402, and one current request 404. In the example of FIG. 4A, the current request 404 is a write request and thus a determination must be made as to which storage device to send the current write request 404, either to the high performance device 136 or the lower performance device 134. Although the example of FIG. 4A shows a HDD as a low performance device and an SSD as a higher performance device, it should be noted that any type of storage devices can be utilized with the principles of the embodiments of the present invention. For example, a high performance SSD can be mixed with a lower performance SSD instead of an HDD. When received, the current request 404 is examined to determine the size of the request and the locality of the request. The locality of a request refers to the target address of the request, which will be compared to other requests as described next.

Referring back to FIG. 3, the locality of the current request is compared to the locality of the other pending request and I/O requests completed in the recent past, in operation 306. Turning to FIG. 4A, the pending requests 402 are examined to determine their locality. Similarly, the locality of I/O requests completed in the recent past can be examined to determine their locality. As will be described in greater detail subsequently, the locality of the pending request 402 and other recently completed I/O requests combined with the locality of the current request 404 affects the drive to which the current request will be sent.

Turning back to FIG. 3, a storage device is selected to receive the current request based on the performance ratio of the drives, they type and size of the current request, and the locality of the current request compared to the locality of the other pending requests and to the locality of other recently completed I/O requests. Referring to FIG. 4A, the locality of the pending request 402 are compared to the locality of the current request 404 to assist in determining a storage device to send the current request 404. For example, if the pending requests 402 and the current requests are sequential, the current request 404 generally is sent to the lower performing storage device, such as the HDD 134. However, because SSDs provide superior bandwidth and latency compared to HDDs, especially for random read or write access, when the locality of the various requests target non-sequential locations the current request 404 generally is sent to the higher performance drive, such as the SSD 136. This is because the required movement of the disk head in a HDD makes such write requests very slow.

Turning back to FIG. 3, a decision is then, in operation 310, made as to whether the current request will be sent to the higher performance storage device. If the current request will be sent to the higher performance storage device, the method 300 branches to operation 312. Otherwise, the method 300 branches to operation 314.

In operation 312, the current request is sent to the higher performance device. As mentioned previously, the required movement of the disk head in a HDD makes HDD storage devices very slow for non-sequential writes. As such, for small requests or when the locality of the pending requests and the current request indicate non-sequential writes, the current request generally is sent to the higher performance device, such as a SSD 136.

In operation 314, the current request is sent to the lower performance device. If the pending requests and the current requests are sequential, the current request generally is sent to the lower performing storage device, such as the HDD 134. In addition, when the current request is large is size, the current request also generally is sent to the lower performing storage device, since the disk head movement is similar in a HDD for large requests to that required for a plurality of sequentially targeted requests.

In addition to load balancing across single instance storage devices as illustrated in FIG. 4A, the principles of the embodiments of the present invention can further be utilized with a pool of devices with similar performance characteristics. For example, FIG. 4B illustrates pools of devices are utilized for handling write requests utilizing the methods of the embodiments of the present invention. Similar to FIG. 4A, FIG. 4B shows an I/O request queue 400 having a plurality of pending I/O requests 402, and one current request 404. However, in the example of FIG. 4B, a determination must be made as to which pool of storage devices to send the current write request 404, either to the lower performance storage device pool 410 or the high performance storage device pool 412.

In one embodiment, each pool of storage devices 410 and 412 is hidden behind a RAID, and thus can be treated in a manner similar to above. That is, the lower performance storage device pool 410 can be regarded as a single logical lower performance storage device and the high performance storage device pool 412 can be regarded as a single logical lower performance storage device. In which case, in operation 310, a decision is made as to which storage device pool to send the current request.

In a further embodiment, the storage devices in each storage device pool 410 and 412 can be exposed, thus allowing the embodiments of the present invention to regard each of the storage devices in each pool as a separate device. In this embodiment, operation 310 remains the same. That is, a decision is made, in operation 310, as to which storage device pool 410 or 412 to send the current request. Then, to balance the load among the devices of the selected storage device pool 410 or 412, the particular device within the selected storage pool having the least amount of pending requests is selected to receive the current request.

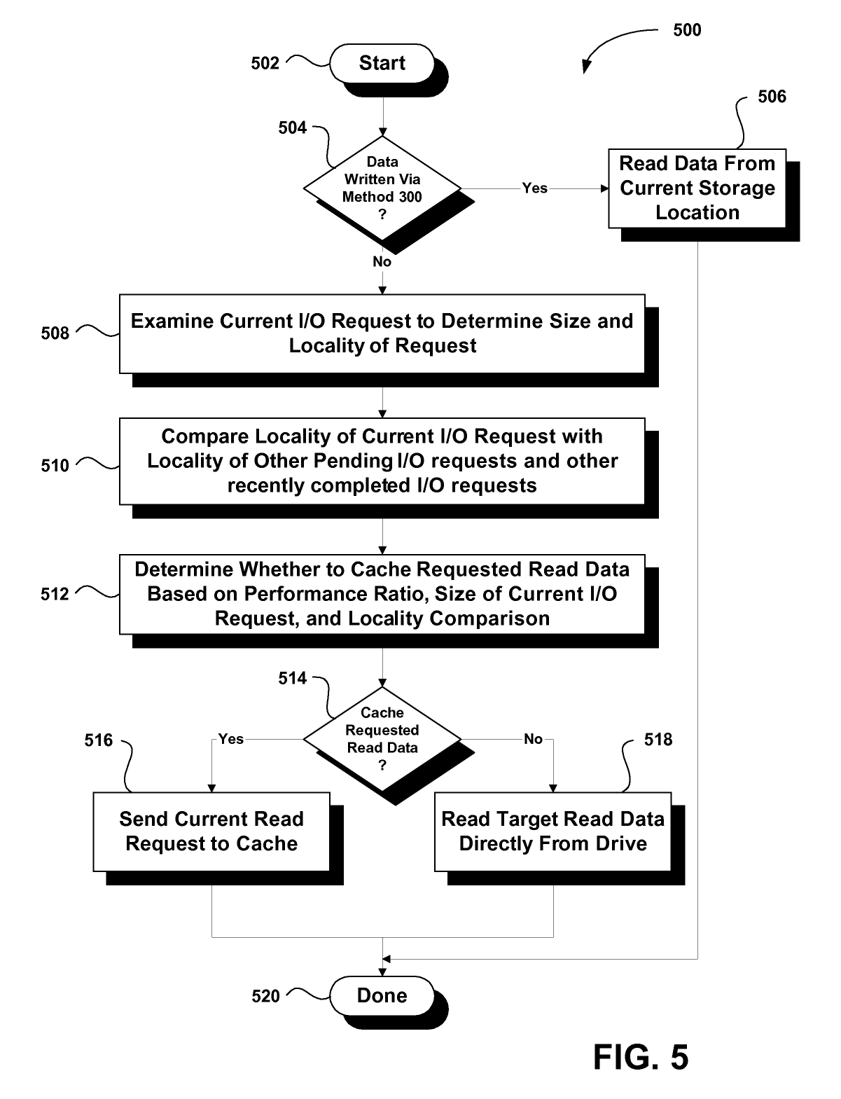

Post process operations are performed in operation 316. Post process operations can include, for example, writing data to the selected storage device, receiving additional requests, and other post process operations that will be apparent to those skilled in the art with the hindsight afforded by a careful reading of the present disclosure. Once data is written to the storage devices using the load balancing of the embodiments of the present invention, the data generally is correctly balanced for subsequent read requests. However, embodiments of the present invention can also perform load balancing during read requests by balancing whether to populate the cache during particular read request, as described next with reference to FIG. 5.

FIG. 5 is a flowchart showing a method 500 for populating cache when using multiple storage devices with different performance characteristics in order to improve system I/O throughput, in accordance with an embodiment of the present invention. In an initial operation 502, preprocess operations are performed. Preprocess operations can include, for example, determining a performance ratio for the drives of the computer system, installing an Option-ROM BIOS to facilitate I/O, receiving a request, and other preprocess operations that will be apparent to those skilled in the art with the hindsight provided after a careful reading of the present disclosure.

In operation 504, a decision is made as to whether the data requested was written using the load balancing paradigm of the embodiments of the present invention. If the data requested was written using the load balancing paradigm of the embodiments of the present invention, the method branches to operation 506, wherein the data is read from the particular storage device which stores the data. Otherwise, the method continues to operation 508 where the current read request is examined.

When the data requested was written using the load balancing paradigm of the embodiments of the present invention, the data generally already is correctly balanced. Thus, in operation 506, the requested data is read directly from the particular device to which it was initially written without caching. Thereafter, the method 500 branches to operation 520.

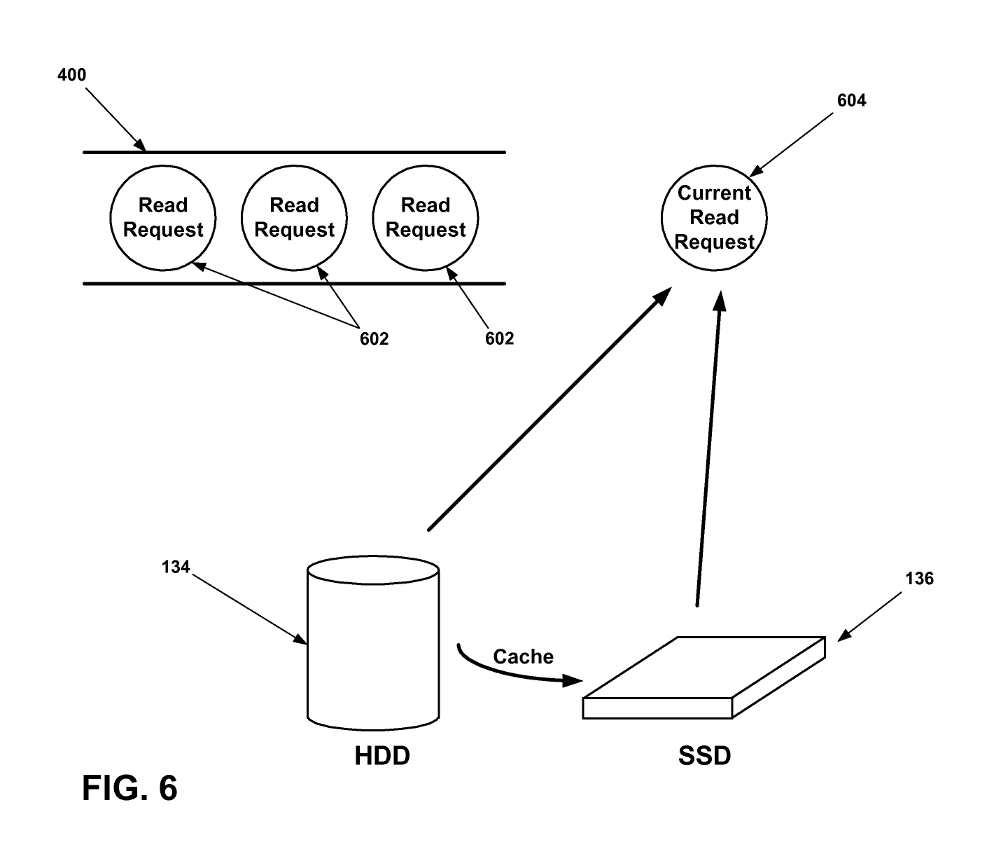

In operation 508, the current read request is examined to determine the size and the locality of the request. During read operations, embodiments of the present invention populate the cache based in part on the size of the request and the locality of the received request. FIG. 6 illustrates one manner in which read requests are handled utilizing the methods of the embodiments of the present invention. FIG. 6 shows an I/O request queue 400 having a plurality of pending I/O requests 602, and one current request 604. In the example of FIG. 6, the current request 604 is a read request and thus a determination must be made as to whether to populate the cache with the requested read data. Although the example of FIG. 6 shows a HDD as a low performance device and an SSD as a higher performance device, it should be noted that any type of storage devices can be utilized with the principles of the embodiments of the present invention. For example, a high performance SSD can be mixed with a lower performance SSD instead of an HDD. When received, the current request 604 is examined to determine the size of the request and the locality of the request. The locality of the current request refers to the target address of the current request, which will be compared to other requests.

Referring back to FIG. 5, the locality of the current request is compared to the locality of the other pending requests and to the locality of other recently completed I/O requests, in operation 510. Turning to FIG. 6, the pending requests 602 are examined to determine their locality. In addition, the locality of recently completed I/O requests are examined. As will be described in greater detail subsequently, the locality of the pending request 602 and other recently completed I/O requests combined with the locality of the current request 604 affects whether the current request will be cached.

Turning back to FIG. 5, a determination is made as to whether to cache the requested read data based on the performance ratio of the drives, the type and size of the current request, and the locality of the current request compared to the locality of the other pending requests and other recently completed I/O requests. Referring to FIG. 6, the locality of the pending request 602 are compared to the locality of the current request 604 to assist in determining whether to cache the target data of the current request 604. For example, if the pending requests 602 and the current request 604 are sequential, the current request 604 generally is read directly from the storage device without caching. However, when the locality of the various requests target non-sequential locations the target data of the current request 604 generally is cached, for example using the higher performance drive, such as the SSD 136.

Turning back to FIG. 5, a decision is then, in operation 514, made as to whether the target data of the current request will be sent to the cache. If the target data of the current request will be sent to the cache, the method 500 branches to operation 516. Otherwise, the method 500 branches to operation 518.

In operation 516, the current request is sent to the cache. For small requests or when the when locality of the pending requests and the current request indicate non-sequential writes, the target data of the current request generally is sent to the cache. In this manner, performance can be improved if the same batch of requests is received again.

In operation 518, the target data of the current request is read directly from the appropriate storage device without being cached. For example, if the pending requests and the current requests are sequential, the target data of the current request generally is read directly from the appropriate storage device without being cached. In addition, when the current request is large is size, the current request also generally is read directly from the appropriate storage device without being cached. Post process operations then are performed in operation 520. Post process operations can include, for example, writing data to the selected storage device, receiving additional requests, and other post process operations that will be apparent to those skilled in the art with the hindsight afforded by a careful reading of the present disclosure.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for distributing storage input/output (I/O) loads across multiple storage devices with different performance characteristics, comprising:
examining a current I/O request to determine characteristics of the current I/O request;
comparing the characteristics of the current I/O request to characteristics of other pending I/O request;
selecting a storage device from a plurality of storage devices based on the characteristics of the current I/O request and the characteristics of other pending I/O request, wherein the plurality of storage devices includes at least one storage device having higher performance characteristics than another storage device of the plurality of storage devices; and
utilizing the selected storage device with the current I/O request.

2. A method as recited in claim 1, wherein a characteristic of the current I/O request is a size of the current I/O request.

3. A method as recited in claim 2, wherein a further characteristic of the current I/O request is a locality of the current I/O request.

4. A method as recited in claim 1, wherein a characteristic of a pending I/O request is a locality of the pending I/O request.

5. A method as recited in claim 1, wherein the higher performance storage device is selected when the locality of the pending requests and the locality of current I/O request target non-sequential locations.

6. A method as recited in claim 1, wherein the storage device is selected based on a performance ratio between the storage devices of the plurality of storage devices.

7. A method as recited in claim 1, wherein the higher performance storage device is a solid state drive, and wherein a lower performance storage device is a hard disk drive.

8. A system for distributing storage input/output (I/O) loads across multiple storage devices with different performance characteristics, comprising:
an I/O request queue queuing a plurality of pending requests;
a plurality of storage devices in communication with the I/O request queue, wherein the plurality of storage devices includes a low performance storage device and a higher performance storage device; and
a processor executing program instructions that examine a current I/O request to determine characteristics of the current I/O request, and compare the characteristics of the current I/O request to characteristics of other pending I/O request,
wherein the processor selects a storage device from a plurality of storage devices based on the characteristics of the current I/O request and the characteristics of other pending I/O request, and wherein the selected storage device is utilized with the current I/O request.

9. A system as recited in claim 8, wherein a characteristic of the current I/O request is a size of the current I/O request.

10. A system as recited in claim 9, wherein a further characteristic of the current I/O request is a locality of the current I/O request.

11. A system as recited in claim 8, wherein a characteristic of a pending I/O request is a locality of the pending I/O request.

12. A system as recited in claim 8, wherein the higher performance storage device is selected when the locality of the pending requests and the locality of current I/O request target non-sequential locations.

13. A system as recited in claim 8, wherein a lower performance storage device is selected when the locality of the pending requests and the locality of current I/O request target sequential locations.

14. A system as recited in claim 8, wherein the higher performance storage device is a solid state drive, and wherein a lower performance storage device is a hard disk drive.

15. A computer program embodied on a computer readable medium for distributing storage input/output (I/O) loads across multiple storage devices with different performance characteristics, comprising:
computer code for examining a current I/O request to determine characteristics of the current I/O request;
computer code for comparing the characteristics of the current I/O request to characteristics of other pending I/O request;
computer code for selecting a storage device from a plurality of storage devices based on the characteristics of the current I/O request and the characteristics of other pending I/O request, wherein the plurality of storage devices includes at least one storage device having higher performance characteristics than another storage device of the plurality of storage devices; and
computer code for utilizing the selected storage device with the current I/O request.

16. A computer program as recited in claim 15, wherein a characteristic of the current I/O request is a size of the current I/O request.

17. A computer program as recited in claim 16, wherein a further characteristic of the current I/O request is a locality of the current I/O request.

18. A computer program as recited in claim 15, wherein a characteristic of a pending I/O request is a locality of the pending I/O request.

19. A computer program as recited in claim 15, wherein the higher performance storage device is selected when the locality of the pending requests and the locality of current I/O request target non-sequential locations.

20. A computer program as recited in claim 15, wherein a lower performance storage device is selected when the locality of the pending requests and the locality of current I/O request target sequential locations.
